(19) United States
(12) Patent Application Publication
(10) Pub. No.: US 2008/0291272 A1
(43) Pub. Date: Nov. 27, 2008

(54) METHOD AND SYSTEM FOR REMOTE ESTIMATION OF MOTION PARAMETERS

(76) Inventors: Nils Oliver Krahnstoever, Schenectady, NY (US); Gianfranco Doretto, Albany, NY (US); Peter Tu, Niskayuna, NY (US); Jens Rittscher, Ballston Lake, NY (US); Mark Grabb, Burnt Hills, NY (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 11/752,010

(22) Filed: May 22, 2007

(51) Int. Cl. H04N 7/18; H04N 5/225

(52) U.S. Cl. 348/143; 348/169; 348/262; 348/E05.024; 348/E05.025; 348/E07.085

(57) ABSTRACT

A system and method, the method including calibrating an image capturing system; capturing a video sequence with the image capturing system; detecting a subject of interest in the video sequence; tracking the subject over a period of time; and extracting data associated with a motion of the subject based on the tracking.

### BACKGROUND

The present disclosure relates, generally, to a system and method for detecting and identifying people or objects within crowded environments, and more particularly to an image capturing system for determining the location of subjects within a crowded environment of a captured video sequence and presenting motion data extracted from the video.

### SUMMARY

In some embodiments, a method including calibrating an image capturing system, capturing a video sequence of images with the image capturing system, detecting a subject of interest in the video, tracking the subject over a period of time, and extracting data associated with a motion of the subject based on the tracking may be provided.

In some embodiments of the present disclosure, a method may be provided that includes calibrating an image capturing system, capturing a video sequence of images with the image capturing system, applying a crowd segmentation process to the video sequence to isolate the subject, tracking the subject over a period of time, and extracting data associated with a motion of the subject based on the tracking.

In some embodiments herein, the calibrating may include an internal calibration process and an external calibration process for the image capturing system. In some embodiments, the calibrating of the image capturing system may be accomplished relative to a location of the image capturing system and includes determining geometrical information associated with the location.

In some embodiments a system is provided. The system may include image capturing system and a computing system connected to the image capturing system. Further, the computing system may be adapted to calibrate the image capturing system, detect a subject of interest in a video sequence captured by the image capturing system, track the subject over a period of time, and extract data associated with a motion of the subject based on the tracking.

### BRIEF DESCRIPTION OF THE DRAWINGS

FIG. 1 is an illustrative flow diagram for a process, according to some embodiments herein;

FIG. 2 provides an illustrative depiction of a process, in accordance with some embodiments herein;

FIG. 3 is an illustrative depiction of an image captured by an image capturing system, in accordance with some embodiments herein;

FIG. 4 is an exemplary illustration of an image, including graphic overlays, in accordance herewith;

FIG. 5 is an exemplary illustration of an image 500, in accordance herewith;

FIG. 6 is an illustrative depiction of an image 600, in accordance herewith;

FIG. 7 is an illustrative depiction of an image, in accordance with aspects herein;

FIG. 8 is an illustrative depiction of an image, in accordance with some embodiments herein;

FIG. 9 is an illustrative depiction of an image, in accordance with some embodiments herein;

FIG. 10 is an illustrative depiction of an image, in accordance with some embodiments herein; and

FIG. 11 is an illustrative rendering, in accordance with some embodiments herein.

### DETAILED DESCRIPTION

In some embodiments, methods and systems in accordance with the present disclosure may visually and, in some instances automatically, extract information from a live or a recorded broadcast sequence of video images (i. e., a video). The extracted information may be associated with one of more subjects of interest captured in the video. In some instances, the extracted information may pertain to motion parameters for the subject. The extracted data may be further presented to a viewer or user of the data in a format and manner that is easily understood by the viewer.

Since the information is extracted or derived from the video image, the viewer is presented with more information than may be available in the original video sequence. The extracted information may provide the basis for a wide variety of generated statistics and visualizations. Such produced statistics and visualizations may be presented to a viewer to enhance a viewing experience of the video sequence.

In some embodiments, a method for remote visual estimation of at least one parameter associated with a subject of interest is provided herein. In particular instances, the at least one parameter may be a speed, direction, acceleration, and other motion parameters associated with the subject. The method may include capturing the subject on video and using, for example, computer vision techniques and processes, to extract data for estimating motion parameters associated with the subject.

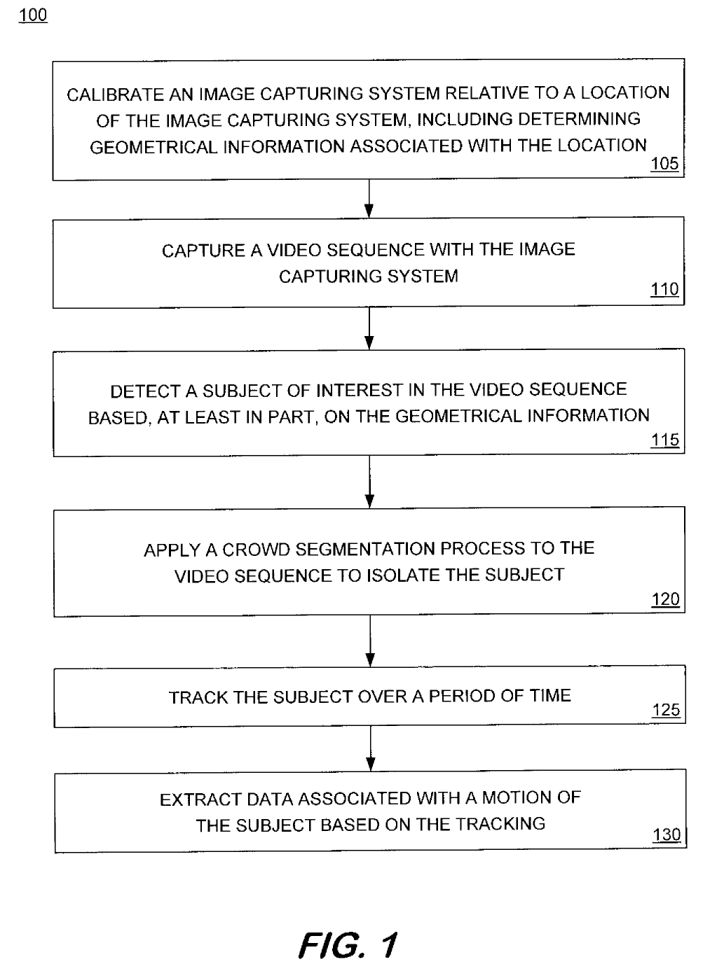

FIG. 1 is an illustrative flow diagram for a process 100, according to some embodiments herein. At operation 105, an imaging system is calibrated relative to a location of the image capturing system. The calibration may be manual, automatic, or a combination thereof. The image capturing systems herein may include a single camera device. However, in a number of embodiments the image capturing systems herein may include multiple camera devices. The camera device(s) may be stationary or movable. In addition to an overall stationary or ambulatory status of the camera device, the camera device(s) may have an ability to pan/tilt/zoom. Thus, even a stationary camera device(s) may be subject to a pan/tilt/zoom movement.

In an effort to accurately correlate an image captured by the image capturing system with the real-world in which the image capturing system and images captured thereby exist, the image capturing system is calibrated. The calibration of the image capturing system may include an internal calibration wherein a camera device and other components of the image capturing system are calibrated relative to parameters and characteristics of the image capturing system. Further, the image capturing system may be externally calibrated to provide an estimation or determination of a relative location and pose of camera device(s) of the image capturing system with regards to a world-centric coordinate framework. A desired result of the calibration process of operation 105 is an accurate estimation of a correlation between real world, 3-dimensional (3D) coordinates and an image coordinate view of the camera device(s) of the image capturing system.

The calibration process of operation 105 may include the acquisition and determination of certain knowledge information of the location of the image capturing system. The information regarding the location of the image capturing system may be referred to herein as geometrical information. For example, in an instance the image capturing system is deployed at a sporting event, the calibration process may include learning and/or determining the boundaries of the arena, field, field of play, or parts thereof. In this manner, knowledge of the extent of a field of play, arena, boundaries, goals, ramps, and other fixtures of the sporting event may be used in other processing operations.

In some embodiments, the geometrical information and other data relating to the calibration process of operation 105 may be used in coordinating and reconciling images captured by more than one camera device belonging to the image capturing system.

At operation 110, a sequence of video images or a video is captured by the image capturing system. The video may be captured from multiple angles in the instances multiple camera devices located at more than one location are used to capture the video simultaneously.

At operation 115, a process to detect a subject of interest in the captured video is performed. The process of detecting the subject may be based, in part, on the knowledge or geometrical information obtained in the calibration operation 105. In some embodiments, such as the context of a sporting event, known characteristics of the field such as the location of the playing surface relative to camera, the boundaries of the field, an expected range of motion for the players in the arena (as compared to non-players) may be used in the detection and determination of the subject of interest.

In some embodiments, the subject(s) of interest may be detected by determining objects in the foreground of the captured video by a process such as, for example, foreground-background subtraction. Detection processes that involve determining objects in the foreground may be used in some embodiments herein, particularly where the subject of interest has a tendency to move relative to a background environment. The subject detection process may further include processing using a detection algorithm. The detection algorithm may use geometrical information, including that information obtained during calibration process 105, and image information associated with the foreground processing to detect the subject of interest.

It should be appreciated that other techniques and processes to detect the subject(s) of interest in the captured video and compatible with other aspects of the present disclosure may be used in operation 115.

In some embodiments, a further complexity may be encountered in that the subject of interest may be in close proximity with other subjects and objects. In some embodiments, the particular subject of interest may be in close proximity with other subjects of similar size, shape, and/or orientation. In these and other instances, operation 120 provides a mechanism for isolating the subject of interest from the other objects and subjects. In particular, operation 120 provides a crowd segmentation process to separate and isolate the subject of interest from a “crowd” of other objects and subjects.

In accordance herewith, either operation 115 or 120 may be applied or used in processing a video sequence. In some embodiments, the use of either operation 115 or operation 120 may be based on the images captured or processed by the methods and systems herein.

At operation 125, the subject of interest, having been visually detected in the captured video and separated from the background and other objects and subjects, is tracked over a period of time. That is, location information associated with the subject of interest is determined for the subject of interest for a successive number of images of the captured video. The location data associated with the subject of interest over a period of time is also referred to herein as motion data.

The motion data provides an indication of the motion of the subject of interest. In some embodiments, the motion data associated with the subject of interest may be estimated or determined using geometrical knowledge of the image capturing system and the captured video that is obtained or learned by the image capturing system or available to the image capturing system.

In some embodiments, motion data associated with the subject of interest over a period of time uses fewer than each and every successive image of the captured video. For example, the tracking aspects herein may use a subset or “key” images of the captured video (e.g., 50% of the captured video).

Tracking operation 125 may include a process of conditioning or filtering the motion data associated with the subject of interest to provide, for example, a smooth, stable, or normalized version of the motion data.

At operation 130, a data extracting process extracts data associated with the motion data. The extracted data may include determining or deriving a speed, a maximum speed, a direction of motion, an acceleration, an average acceleration, a total distance traveled, a height jumped, a hang time calculation, and other parameters related to the subject of interest. For example, in the context of a sporting event, the extracted data may provide, based on the visual detection and tracking of the subject of interest, the speed, acceleration, acceleration, average speed and acceleration, and total distance ran by the player on a specific play or, for example, in a period, quarter, or the entirety of the game up to a particular instance in time.

Some aspects of process 100 may be invoked and performed in an automatic manner. For example, calibration operation 105 may comprise an auto-calibration process for the image capturing system.

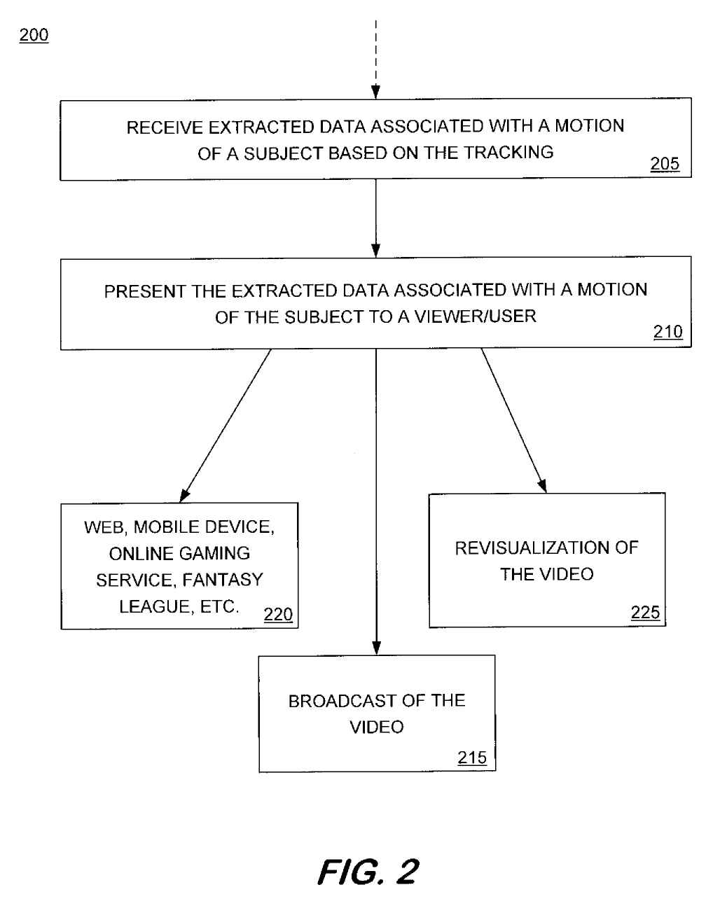

FIG. 2 provides an illustrative depiction of a process 200, in accordance with some embodiments herein. At operation 205, extracted data associated with a motion of a subject of interest is received. Process 200 may, in some embodiments, represent a continuation of process 100. Thus, in some embodiments, the extracted data may be the result of a process such as, for example, process 100.

At operation 210, the extracted data associated with a motion of a subject (i.e., motion data) is presented to a viewer or user. As illustrated at 215, 220, and 225, the extracted data may be provided to a number of destinations including, for example, a broadcast of the video. The processes disclosed herein are preferably sufficiently efficient and sophisticated to permit the extraction and presentation of motion data substantially in real time during a live broadcast of the captured video to either one or all of the destinations of FIG. 2.

In some embodiments, data extracted from a video sequence of a subject may be communicated or delivered to a viewer in one or more ways. For example, the extracted data may be generated and presented to a viewer during a live video broadcast or during a subsequent broadcast (215). In some instances, the extracted data may be provided concurrently with the broadcast of the video, on separate communications channel in a format that is the same or different than the video broadcast. In some embodiments, the broadcast embodiments of the extracted motion data presentation may include graphic overlays. In some embodiments, a path of motion for a subject of interest may be presented in one or more of a video graphics overlay. The graphics overlay may include a location, a line, a pointer, or other indicia to indicate an association with the subject of interest. Text including one or more of an extracted data (e.g., statistic) related to the motion of the subject may be displayed alone or in combination with the subject and/or the path of motion indicator. In some embodiments, the graphics overlay may be repeatedly updated over time as a video sequence changes to provide an indication of a past and a current path of motion (i.e., a track). In some embodiments, the graphics overlay is repeatedly updated and re-rendered so as not to obfuscate other objects in the video such as, for example, other objects in a foreground of the video.

In some embodiments, at least a portion of the extracted data may be used to re-visualize the event(s) captured by the video (225). For example, in a sporting event environment, the players/competitors captured in the video may be represented as models based on the real world players/competitors and re-cast in a view, perspective, or effect that is the same as or different from the original video. One example may include presenting a video sequence of a sporting event from a view or angle not specifically captured in the video. This re-visualization may be accomplished using computer vision techniques and processes, including those described herein, to represent the sporting event by computer generated model representations of the players/competitors and the field of play using, for example, the geometrical information of the image capturing system and knowledge of the playing field environment to re-visualize the video sequence of action from a different angle (e.g., a virtual “blimp” view) or different perspective (e.g., a viewing perspective of another player, a coach, or fan in a particular section of the arena).

In some embodiments, data extracted from a video sequence may be supplied or otherwise presented to a system, device, service, service provider, or network so that a system, device, service, service provider, or network may use the extracted data to update an aspect of the service, system, device, service provider, network, or resource with the extracted data. For example, the extracted data may be provided to an online gaming network, service, service provider, or users of such online gaming networks, services, service providers to update aspects of an online gaming environment. An example may include updating player statistics for a football, baseball, or other type of sporting event or other activity so that the gaming experience may more closely reflect real-world conditions. In yet another example, the extracted data may be used to establish, update, and supplement a fantasy league related to real-word sports/competitions/activities.

In some embodiments, at least a portion of the extracted data may be presented for viewing or reception by a viewer or other user of the information via a network such as the Web or a wireless communication link interfaced with a computer, handheld computing device, mobile telecommunications device (e.g., mobile phone, personal digital assistant, smart phone, and other dedicated and multifunctional devices) including functionality for presenting one or more of video, graphics, text, and audio (220).

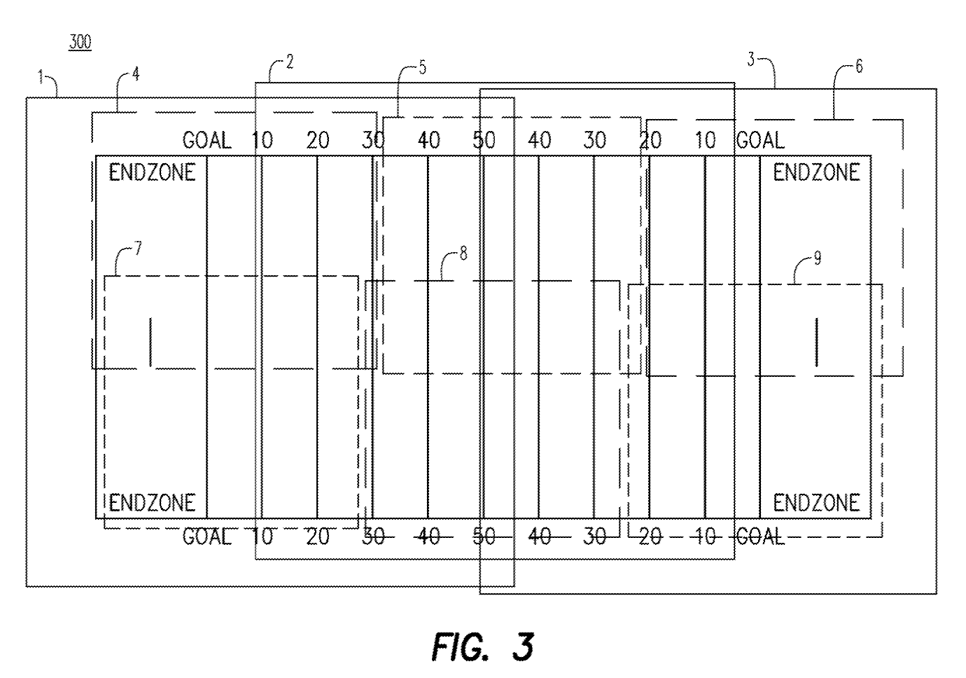

FIG. 3 is an illustrative depiction of an image 300. In particular, image 300 demonstrates the fields of vision that may be captured by an image capturing system in accordance with some embodiments herein. Image 300 is captured by, for example, nine cameras. The fields of vision for the nine cameras are represented by the nine boundaries numbered 1 through 9. In some embodiments, three cameras may be used and the fields of vision for the three cameras are represented by the three boundaries numbered 1 through 3. The multiple cameras offer complete coverage of the playing field 305. The nine camera embodiment provides coverage by at least two cameras for each point on field 305.

The image capturing system including multiple cameras may thus provide a mechanism for a variety of visualizations in accordance with the present disclosure due, at least in part, to the number of perspectives captured by the plurality of cameras.

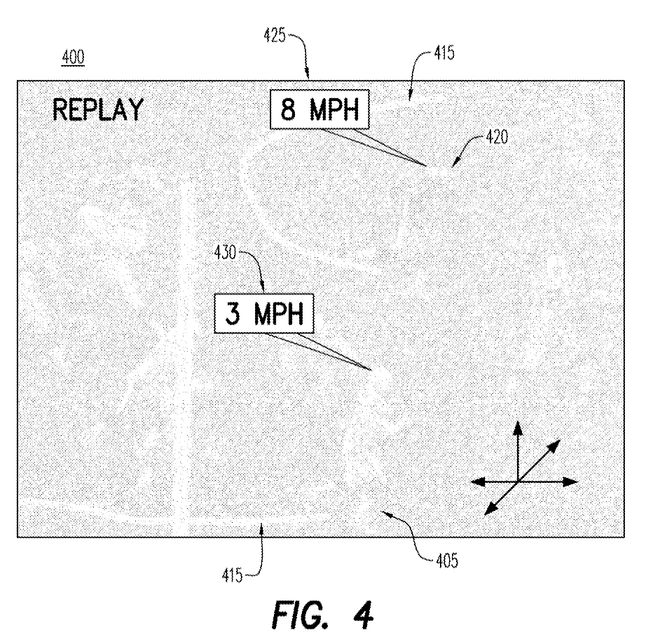

FIG. 4 is an exemplary illustration of an image 400, including graphic overlays representative of motion tracking, in accordance herewith. Image 400 includes an image of a football game. In the course of a broadcast the captured image may be processed in accordance with methods and processes herein to produce a track 410 for player 405 and a track 415 for player 420. The players 405, 420 may be detected and isolated from the other players of image 400, for example, as disclosed in the methods herein. In the instance of image 400, players 405 and 420 are the subjects of interest. Accordingly, telemetry data derived from motion data extracted from the captured video of the football game may be selectively provided for players 405 and 420. The telemetry data presented in image 400 includes tracks 410, 415 (e.g., lines representing the path of travel for the associated player) and an indication of the tracked player's speed 425, 430.

It should be noted that telemetry data for at least some of the other players shown in image 400 may be determined in addition to the data displayed in the graphics overlay for players 405 and 420. In some embodiments, the telemetry information for all of the players in an image is determined, whether or not such information is presented in combination with a broadcast of the video. The determined and processed telemetry data may be presented in other forms, at other times, and to other destinations.

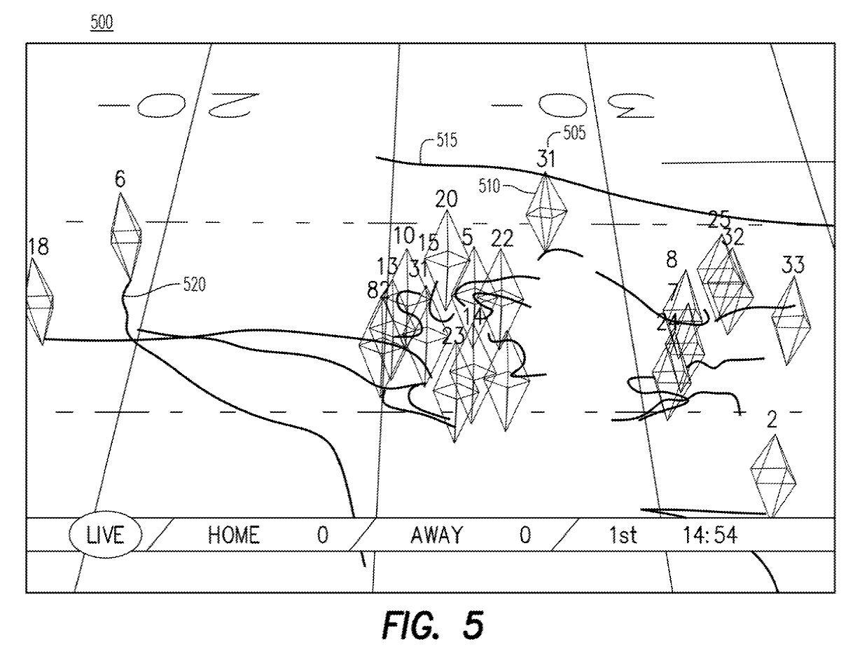

FIG. 5 is an exemplary illustration of an image 500, in accordance herewith. Image 500 includes a presentation of each football player in a captured broadcast image of a football game. As is usual in football, the players are closely bunched in a crowd. According to aspects herein however the players are each visually detected and discerned from the field of play, as well as from each other. This feature is shown by the graphics overlay of each player's number (e.g., 505) in close proximity to the image of the associated player in image 500 (e.g., 510). Additionally, the motion of each player is represented by the tracking graphics overlays associated with each player (e.g., 515 and 520).

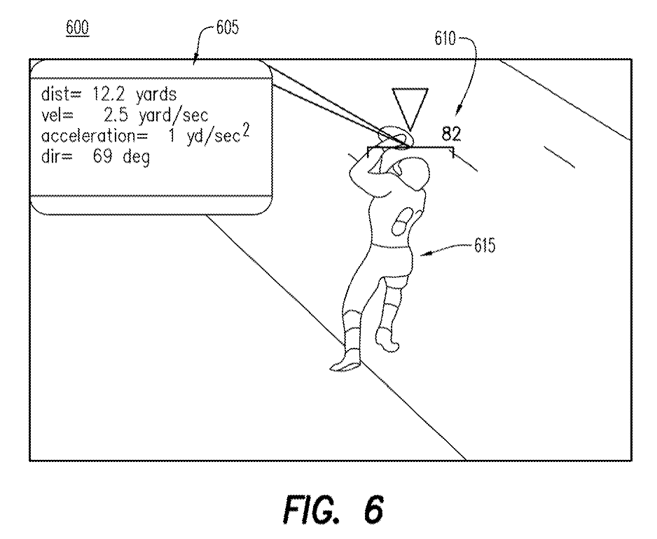

FIG. 6 is an illustrative depiction of an image 600, in accordance herewith. Image 600 is an image of a football player captured during, for example, a live broadcast of a football game. The player's presence and motion have been detected, isolated, and tracked in accordance with the present disclosure. In particular, graphics overlays 605 and 610 are provided to visually provide information to a viewer that is not visually presented in the captured video itself. Graphics overlay 605 is a display area that provides telemetry data derived from motion data associated with football player 615 in image 600. The telemetry data includes a distance traveled on, for example, the play shown in the image, and the velocity, acceleration and direction of the player at the instant of the captured video. It is noted that more, fewer, and other telemetry parameters may be determined and presented for example image 600.

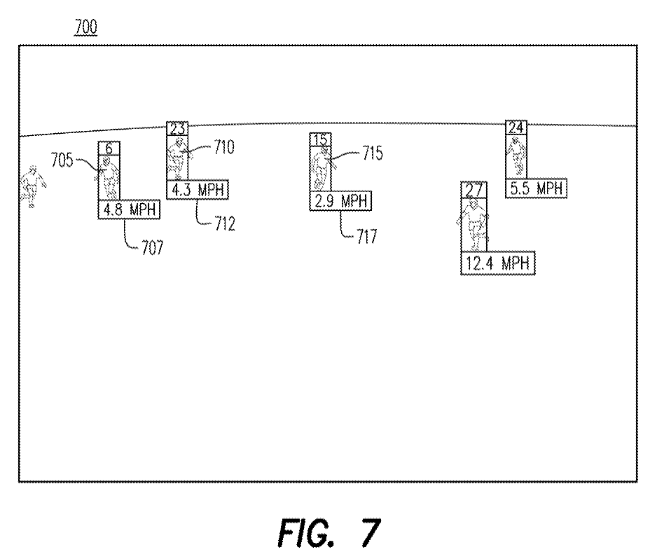

FIG. 7 is an illustrative depiction of an image 700, in accordance with aspects herein. In the example of FIG. 7, shown are a number of soccer players (e.g., 705, 710, 715), each player has telemetry data (e.g., 707, 712, 717) associated therewith and visually presented in a graphics overlay that is in close proximity with the images of the players in image 700. As illustrated, for each player the graphics overlay includes the player's number and the speed of the player at the time of the image capture.

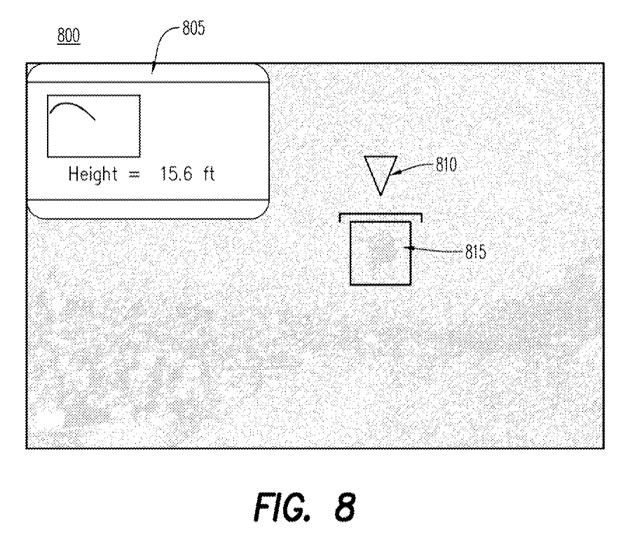

FIG. 8 is an illustrative depiction of an image 800, in accordance with some embodiments herein. Image 800 demonstrates how the processes and methods herein may be applied to numerous applications, including for example, skiing events, track and field events, motor sports, basketball, baseball, hockey, surfing, and freestyle sports such as, the illustrated BMX event of FIG. 8. Graphics overlays 805 and 810 relate to BMX rider 815. Graphics overlay 805 includes a representation of the rider's path of travel and the rider's height above the ground. The presentation of the telemetry data in window 805 may be selectively done so as not to interfere with a view of the BMX rider in image 800. Graphics overlay 810 may or may not be presented for viewing by a viewer.

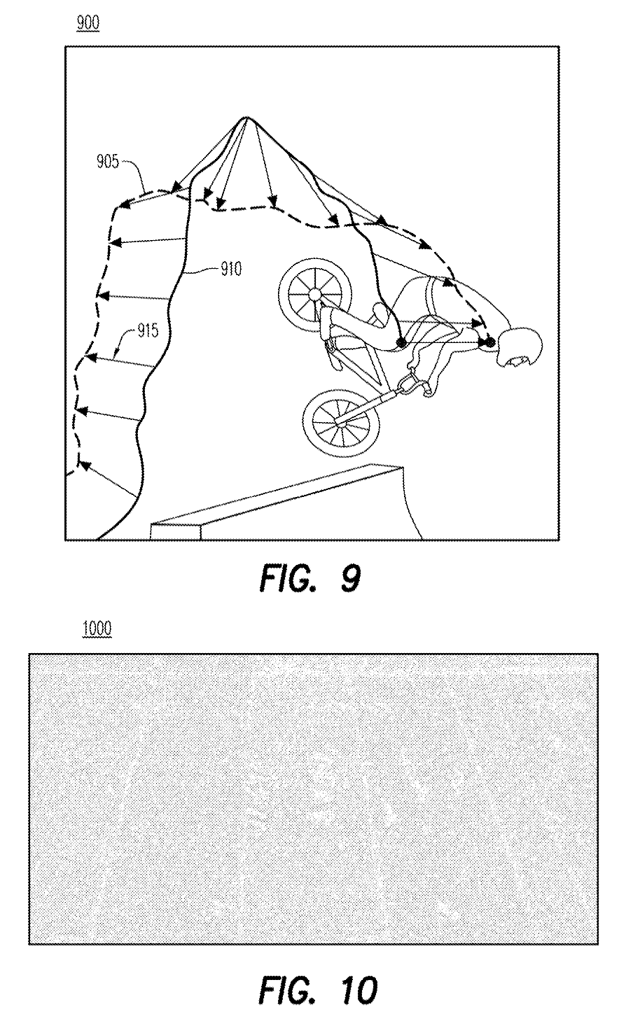

FIG. 9 is an illustrative depiction of an image 900, in accordance with some embodiments herein. The graphic overlays of FIG. 9 include lines 905 and 910 which each track a path of motion for the captured BMX rider on, for example, successive runs. In some embodiments, lines 905 and 910 may be tracks associated with two different riders. In the example of FIG. 9, arrows 915 highlight a difference and the direction of the change between the tracks 905 and 910. The visualizations provided in FIG. 9 illustrate how the processes herein may be used to provide information not available or otherwise presented in the captured video providing the basis for the visualization.

In some embodiments, a visualization in accordance herewith may include a presentation of a rotation exhibited by a subject. For example, a visualization such as that of FIG. 9 may include, in some embodiments, an arrow (not shown) or number, e.g., −180, +270, etc. (not shown) indicative of an amount of rotation performed by a tracked subject.

In some embodiments, a visualization in accordance herewith may include a presentation of an articulation exhibited by a subject. The articulation of a subject may be determined and tracked by, for example, marking or keying on the location of the limbs of the subject.

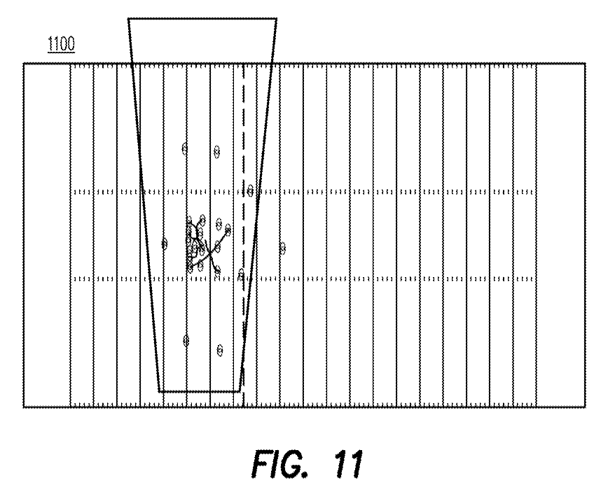

FIG. 10 is an example depiction of a captured image, in accordance with some embodiments herein. In particular, a captured image 1000 of a football game is shown. FIG. 11 is a rendering of the image of FIG. 10. FIG. 11 is, in effect, a virtual playbook re-visualization 1100 of captured image 1000. Re-visualization 1100 provides a top-down view of captured image 1000. Re-visualization 1100 presents computer-generated models of the players and field of FIG. 10. The computer-generated models may be based on the image capturing, detecting, tracking, crowd segmentation, and data extraction operations disclosed herein. The viewing angle presented in re-visualization 1100, top-down, is different than the viewing angle shown in FIG. 10 of captured image 1000.

In some embodiments, a re-visualization of a captured image may provide a rendering of the image from a perspective or angle different than that depicted in the captured image. Such an alternate perspective presentation may be facilitated, in part, by the use of more than one image capture device in an image capturing system. Some of the example views that may be derived or generated and presented based on the captured image and operations herein include, a top-down view (e.g., FIG. 11), a reverse-angle view, a field-level view, a side-elevation view, and other views from various angles and elevations relative to the originally depicted image.

In some embodiments of the methods, processes, and systems herein, a plurality of efficient and sophisticated visual detection, tracking, and analysis techniques and processes may be used to effectuate the visual estimations herein. The visual detection, tracking, and analysis techniques and processes may provide results based on the use of a number of computational algorithms related to or adapted to vision-based video technologies.

While the disclosure has been described in detail in connection with only a limited number of embodiments, it should be readily understood that the disclosure is not limited to such disclosed embodiments. Rather, the disclosure embodiments may be modified to incorporate any number of variations, alterations, substitutions or equivalent arrangements not heretofore described, but which are commensurate with the spirit and scope of the invention. Accordingly, the disclosure is not to be seen as limited by the foregoing description.

What is claimed is:

1. A method comprising:
calibrating an image capturing system;
capturing a video sequence of images with the image capturing system;
detecting a subject of interest in the video;
tracking the subject over a period of time; and
extracting data associated with a motion of the subject based on the tracking.

2. The method of claim 1, further comprising presenting the extracted data in a user-viewable format.

3. The method of claim 2, wherein the user-viewable format comprises at least one of an image graphics overlay, a text presentation, and an audio presentation.

4. The method of claim 2, wherein the presenting of the extracted data is provided in combination with a broadcast of the video sequence.

5. The method of claim 2, wherein the presenting of the extracted data is provided in combination with a computer-generated re-visualization of the video sequence.

6. The method of claim 5, wherein the re-visualization includes generating a model representation of at least the subject.

7. The method of claim 2, wherein the presenting includes depicting, for the subject, at least one of a trajectory of motion, speed, acceleration, and distance traveled.

8. The method of claim 1, wherein the calibrating of the image capturing system includes an internal calibration process and an external calibration process for the image capturing system.

9. The method of claim 1, wherein the image capturing system captures the video sequence including the subject without a marker being located on the subject to aid the image capturing and the subject detecting.

10. The method of claim 9, further comprising merging images captured by two or more of a plurality of cameras of the image capturing system to provide a consolidated view image of the subject.

11. The method of claim 1, wherein the calibrating is accomplished relative to a location of the image capturing system and includes determining geometrical information associated with the location.

12. The method of claim 11, wherein the geometrical information associated with the location includes visually derived geometric constraints for the location.

13. The method of claim 11, wherein the detecting of the subject of interest in the video sequence is based, at least in part, on the geometrical information.

14. The method of claim 1, further comprising stabilizing the video.

15. A method comprising:
calibrating an image capturing system;
capturing a video sequence of images with the image capturing system;
applying a crowd segmentation process to the video sequence to isolate the subject;
tracking the subject over a period of time; and
extracting data associated with a motion of the subject based on the tracking.

16. The method of claim 15, further comprising presenting the extracted data in a user-viewable format, the user-viewable format including at least one of an image graphics overlay, a text presentation, and an audio presentation.

17. The method of claim 16, wherein the presenting of the extracted data is provided in combination with a broadcast of the video sequence.

18. The method of claim 16, wherein the presenting of the extracted data is provided in combination with a computer-generated re-visualization of the video sequence.

19. The method of claim 16, wherein the presenting includes depicting, for the subject, at least one of a trajectory of motion, speed, acceleration, and distance traveled.

20. The method of claim 15, wherein the calibrating includes determining geometrical information associated with the location of the image capturing system.

21. A system, comprising:
image capturing system; and
a computing system connected to the image capturing system, the computing system adapted to:
calibrate the image capturing system;
detect a subject of interest in a video sequence captured by the image capturing system;
track the subject over a period of time; and
extract data associated with a motion of the subject based on the tracking.

22. The system of claim 21, wherein the image capturing system includes at least one of an analog capturing device and a digital image capturing device.

23. The system of claim 21, wherein the computing system is further adapted to present the extracted data in a user-viewable format.

24. The system of claim 21, wherein the computing system is further adapted to re-visualize the video sequence, including generating a model representation of at least the subject.

25. The system of claim 21, wherein the computing system is further adapted to calibrate the image capturing system using an internal calibration process and an external calibration process.

26. The system of claim 21, wherein the image capturing system captures the video sequence including the subject without a marker being located on the subject to aid the image capturing and subject detecting.

27. The system of claim 21, wherein the calibrating includes determining geometrical information associated with the location of the image capturing system and the geometrical information associated with the location includes visually derived geometric constraints for the location.
